(19) United States
(12) Patent Application Publication
(10) Pub. No.: US 2014/0372222 A1
(43) Pub. Date: Dec. 18, 2014

(54) Transmission of Promotional Messages to a Mobile Device

(71) Applicant: Kachyng, Inc, San Francisco, CA (US)

(72) Inventor: Resh Wallaja, San Francisco, CA (US)

(73) Assignee: Kachyng, Inc, San Francisco, CA (US)

(21) Appl. No.: 14/213,580

(22) Filed: Mar. 14, 2014

Related U.S. Application Data
(60) Provisional application No. 61/785,990, filed on Mar. 14, 2013.
(60) Provisional application No. 61/844,843, filed on Jul. 10, 2013.

(51) Int. Cl. G06Q 30/02; H04W 4/14

(52) U.S. Cl. CPC G06Q 30/0267; H04W 4/14
USPC 705/14.64

(57) ABSTRACT

Methods and systems for transmitting a promotional message associated with a promotion to a mobile device are disclosed. The method includes assigning a phone number to a promotion, receiving a call to the phone number assigned to the promotion from the mobile device, registering the call as a missed call at the mobile device, and transmitting the promotional message to the mobile device in response to receiving the call. In some embodiments, the phone number assigned to the promotion is a toll-free number. In some embodiments, the promotion is a coupon, rebate, an electronic refund, or a promotional offer.

### CROSS-REFERENCE TO RELATED APPLICATIONS

This application claims the benefit of U.S. Provisional Application No. 61/785,990, filed Mar. 14, 2013, and U.S. Provisional Application No. 61/844,843, filed Jul. 10, 2013, which are incorporated by reference herein in their entirety.

### BACKGROUND

1. Field of Art

This disclosure relates generally to methods and systems to sending a promotional message to a user's mobile device and, more specifically according to aspects of certain embodiments, to methods and systems for sending a promotional message to a user's mobile device in response to the user placing a missed call to a phone number associated with the promotional message.

2. Description of the Related Art

Advertisers and other senders of promotional messages are keen to send their messages, coupons, rebates, refunds, etc. to users of mobile devices on the mobile devices. However, this typically involves the user first either sending a text message, SMS, etc., or an SMS short code to the sender of promotional messages. In other cases, the user must open and run an application on their mobile device, which then transmits a request for the promotional message to the sender of the promotional message. In any of these situations, the user must typically perform many steps or enter or type in a burdensome amount of information. This can lead to error, and also may be costly for the user considering, for example, SMS costs for sending an SMS or data charges for running the application

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 illustrates a networked environment for transmitting a promotional message to a mobile device, according to one embodiment.

FIG. 2A illustrates example promotional information.

FIGS. 2B and 2C illustrate examples of a user using a mobile device.

FIG. 3 is a block diagram illustrating a computing device, according to one embodiment.

FIG. 4 is a block diagram illustrating a database structure for storing user account data, according to one embodiment.

FIG. 5 is a block diagram illustrating a database structure for storing transaction data, according to one embodiment.

FIG. 6A is a flowchart illustrating a method for transmitting a promotional message to a user's mobile device, according to one embodiment.

FIG. 6B is a flowchart illustrating a method for transmitting a promotional message to a user's mobile device, according to another embodiment.

FIG. 7 is a flowchart illustrating a method for transmitting a promotional message to a user's mobile device, according to another embodiment.

FIG. 8 is a flowchart illustrating a method for receiving a vote for a contestant from a user's mobile device, according to one embodiment.

FIG. 9 is a flowchart illustrating a method for transmitting a merchandise credit to a user's mobile device, according to one embodiment.

FIG. 10 is a block diagram illustrating a networked environment, according to one embodiment.

FIG. 11 is a flowchart illustrating a method for using a missed call to for transmitting information to a user's mobile device, according to one embodiment.

FIG. 12 is a flowchart illustrating a method for using a missed call to for transmitting information to a user's mobile device, according to another embodiment.

### DETAILED DESCRIPTION

Those of ordinary skill in the art will realize that the following description of the present invention is illustrative only and not in any way limiting. Other embodiments of the invention will readily suggest themselves to such skilled persons, having the benefit of this disclosure. Reference will now be made in detail to specific implementations of the present invention as illustrated in the accompanying drawings. The same or similar reference numbers will be used throughout the drawings and the following description to refer to the same or like parts.

### Configuration Overview

According to some embodiments, methods and systems for transmitting a promotional message associated with a promotion to a mobile device are disclosed. A promotion includes, for example, a coupon, a rebate, an electronic refund, or an offer. The method comprises, at a server, assigning a phone number to a first promotion, receiving a call to the phone number assigned to the first promotion from the mobile device, registering the call as a missed call at the mobile device, and transmitting the first promotional message to the mobile device in response to receiving the call. In one embodiment, the method includes determining a phone number of the mobile device from the missed call, and transmitting the first promotional message to the mobile device using the determined phone number of the mobile device. In one embodiment, transmitting the first promotional message to the mobile device comprises generating a graphical user interface for display by the mobile device, where the graphical user interface displays the first promotional message. Other aspects and advantages of various aspects of the present invention can be seen upon review of the figures and of the detailed description that follows.

### Example System Overview

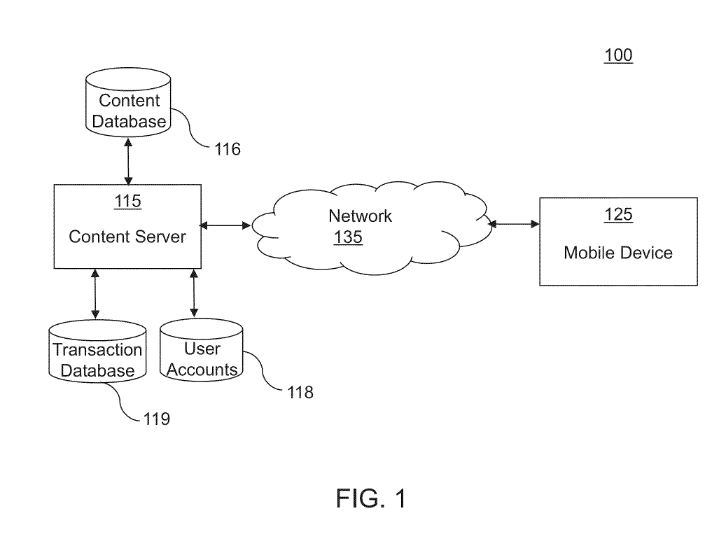

FIG. 1 depicts a networked environment 100 for providing promotional messages to a mobile device, according to one embodiment. As illustrated, one embodiment of the networked environment 100 includes a content server 115 having a corresponding content database 116, user accounts database 118, and transaction database 119; a mobile device 125; and a network 135. The example number of content servers 115, databases 116, 118, and 119, mobile devices 125, and networks 135 illustrated in FIG. 1 can be modified as appropriate in a particular implementation. In practice, there may be additional content servers 115, databases 116, 118, and 119, mobile devices 125, and networks 135. One or more components of networked environment 105 may perform one or more of the tasks described as being performed by one or more other components of networked environment 105. The mobile device 125 is a mobile computing device of a user, which is one embodiment is a cellular phone configured to place and receive phone calls over a mobile communications network. A phone number of the mobile device 125 is stored in the user database 118 in association with user information of the user.

The content server 115 serves promotional messages to the mobile device 125 in response to receiving calls from the mobile device 125. Promotional messages identify a promotion offered by a promoter (such as a retailer), where the promotion provides a discount, sale, or special offer for goods or services provided by the promoter. For example, the promotion may provide a specified amount deducted from a user's purchase, a specified percentage off a user's purchase, a free item with purchase of another item, and so forth. The promoter specifies restrictions for the promotion, such as a time of expiration of the promotion, the total number of times a user can use the promotion, a total number of users who can use the promotion, an age a user must be to use the promotion, geographical regions in which the promotion can be used, or the like. In one embodiment, the transaction database 119 stores information for each promotion, including the restrictions for the promotion specified by the promoter, status information for the promotion (e.g., whether it is active or has expired), the promotion's redemption count, and the like.

Information about the promotion offered by the promoter may be made available to users by a variety of visual and/or audio formats. For example, the promotional information may be printed in various types of print media (e.g., newspapers or magazines), displayed on a billboard or near a point of sale location in a store, included in an email or on a webpage, displayed during a television program, and so forth. As another example, the promotion information may be audio message played during a radio or television program.

The content server 115 assigns a unique phone number to each promotion. A user who desires to use a promotion calls the phone number assigned to the promotion using a mobile device 125. The content server 115 registers the call as a missed call at the mobile device 125 so that the user does not incur a cost for the call. In response to receiving the call, the content server 115 transmits a promotional message to the mobile device 125, which provides instructions for redeeming the promotion, a coupon, a verification code, or other information enabling the user to redeem the promotion. In one embodiment, the content server 115 accesses the content database 116 to retrieve the promotional messages, which are stored in the content database 116 in association with an identifier of the promotion corresponding to each promotional message.

In some cases, the content server 115 determines a geographic location of the mobile device 125 when the mobile device 125 is used to call a number assigned to a promotion. The content server 115 may use the geographical location of the mobile device 125 to send geographic-based promotional information to the mobile device 125. For example, the content server 115 may transmit a message with a location of the nearest store where the promotional message can be redeemed, or may use the geographic location to identify a promotion for a store near the mobile device 125. Alternatively or in addition, the determination of the geographical location of the mobile device 125 can be used to determine user eligibility for using a promotion.

Although embodiments of the content server 115 are described herein with respect to providing promotional messages to mobile devices, in other embodiments, the content server 115 serves other types of content in response to calls placed to a unique phone number assigned to the content. For example, the content server 115 may distribute merchandise credits in addition to or instead of promotional content. Furthermore, other embodiments of the content server 115 are configured to count votes for a contest in response to calls to one or more unique phone numbers associated with the contest. In this case, the content server 115 updates voting counts for the contest, and may not serve content to mobile devices 125.

The content server 115 serves promotional content to mobile device 125 over network 135. In one embodiment, network 135 comprises a mobile communications network, such as Public Land Mobile Network (PLMN), a telephone network (e.g., a Public Switched Telephone Network (PSTN)), and/or a wireless network. In various embodiments, network 135 additionally or alternatively includes an Internet protocol (IP) based network, such as the Internet.

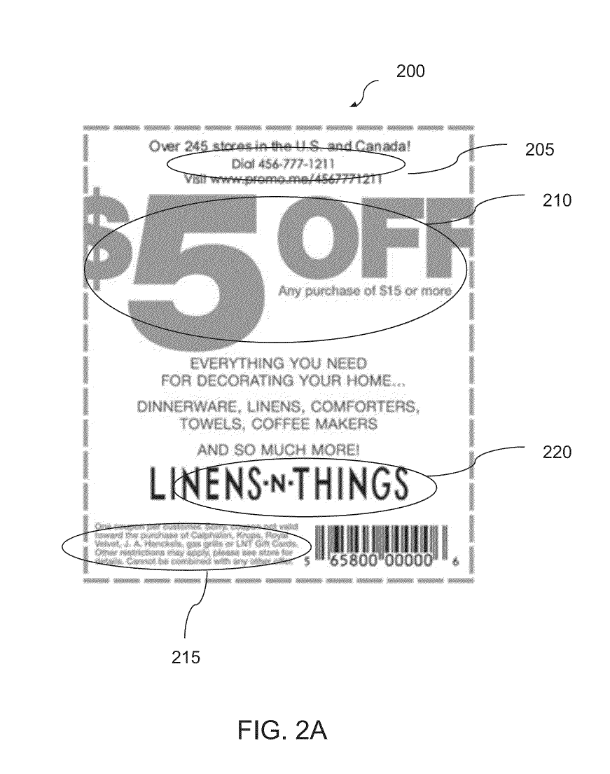

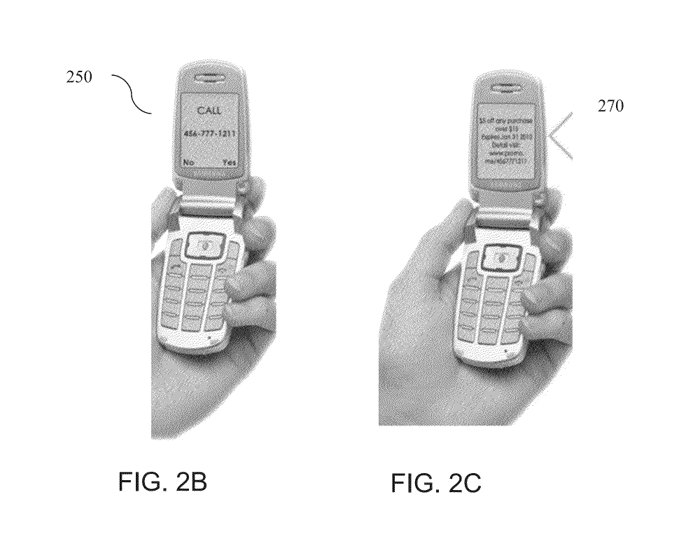

FIG. 2A illustrates example promotional information 200 as may be found in a print medium (e.g., a magazine, a newspaper, etc.). The promotional information 200 includes a promotion 210 for a promoter 220, and includes an invitation to dial a unique phone number 205. Also, promotional message 200 may include terms and conditions 215 associated with the promotion, including, for example, an expiration date (not shown). A user uses their mobile device 125 to dial the unique phone number on promotional message, as illustrated in FIG. 2B. In response to the call from the user's mobile device 125, the content server 115 registers a missed call. In various embodiments, the content server 115 causes a customized ring tone or message for the duration of the call. For example, the customized message may include a brief summary or identification of the promotion, may thank the user for calling, and/or instruct the user to hang up, etc. At the mobile device 125, the call made to the unique phone number is registered as an unanswered call. Thus, the user does not incur an expense for the call. In response to receiving the call from the mobile device 125, the content server 115 transmits the promotional information to the mobile device 125. For example, FIG. 2C illustrates the mobile device 125 displaying an SMS message 270 containing promotional information. In other embodiments, a message comprising multimedia content may be transmitted by the content server 115 to user mobile device 125. In some embodiments, a promotional message transmitted to the mobile device 125 may include a link to a web site. In other embodiments, a promotional message transmitted to the mobile device 125 may include a connection to a call center.

### Example Computing Configuration

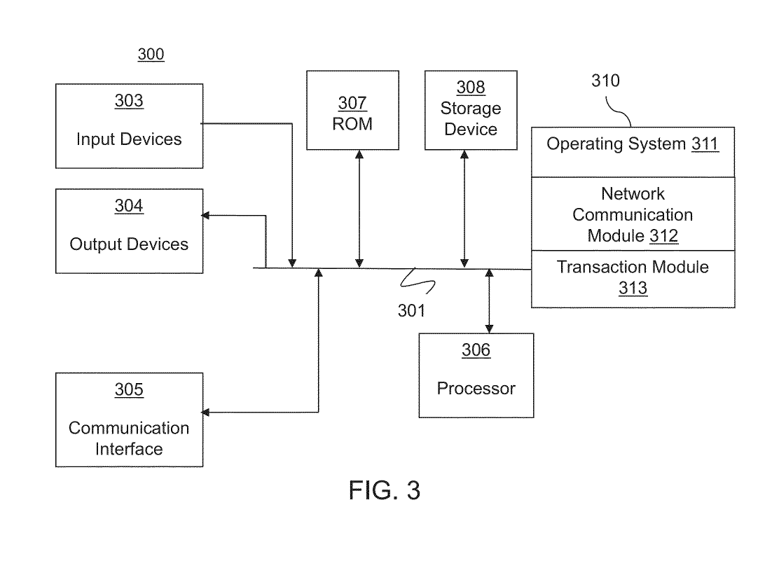

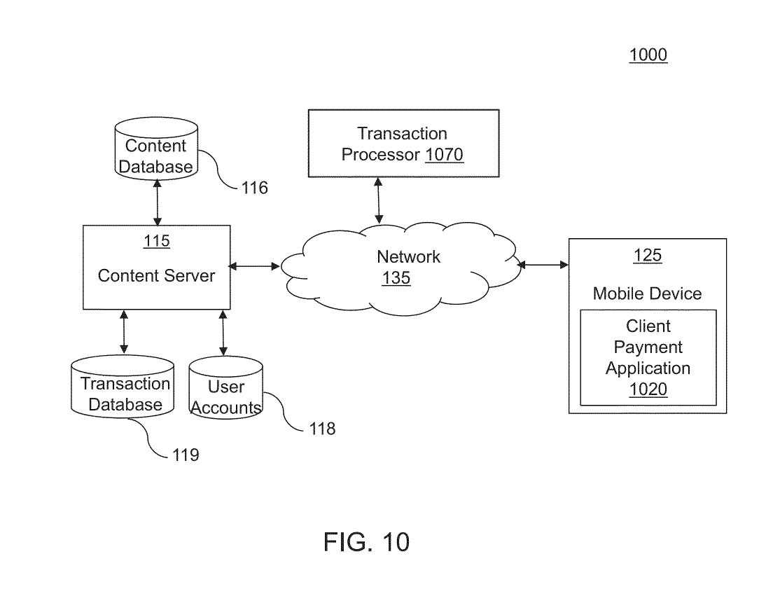

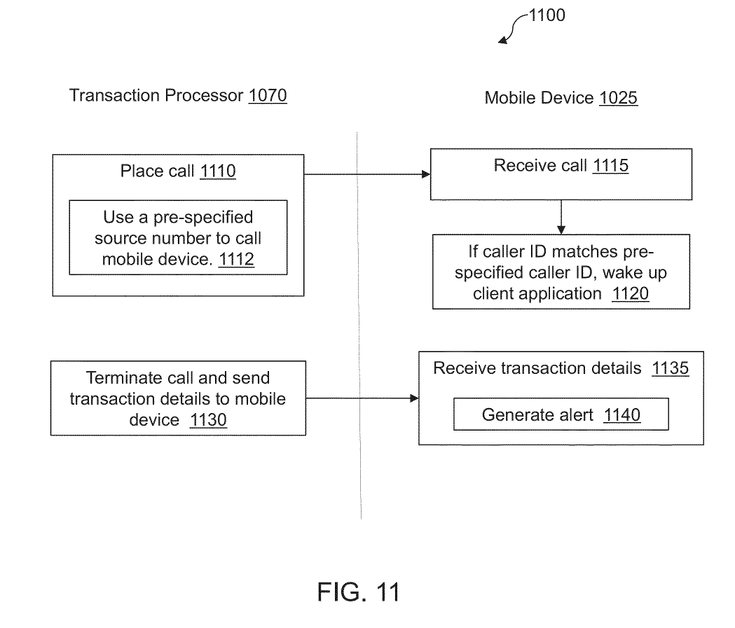

FIG. 3 is an exemplary diagram of a computing device 300 that may be used to implement aspects of certain embodiments of the present invention, such as aspects of content server 115 or transaction processor 1070 (discussed further with reference to FIGS. 10 and 11). Computing device 300 may include a bus 301, one or more processors 306, a main memory 310, a read-only memory (ROM) 307, a storage device 308, one or more input devices 303, one or more output devices 304, and a communication interface 305. Bus 301 may include one or more conductors that permit communication among the components of computing device 300.

Processor 306 includes any type of conventional processor, microprocessor, or processing logic that interprets and executes instructions. Main memory 310 includes a random-access memory (RAM) or another type of dynamic storage device that stores information and instructions for execution by processor 305. ROM 307 may include a conventional ROM device or another type of static storage device that stores static information and instructions for use by processor 306. Storage device 308 may include a magnetic and/or optical recording medium and its corresponding drive.

Input device(s) 303 may include one or more conventional mechanisms that permit a user to input information to computing device 300, such as a keyboard, a mouse, a pen, a stylus, handwriting recognition, voice recognition, biometric mechanisms, and the like. Output device(s) 304 may include one or more conventional mechanisms that output information to the user, including a display, a projector, an A/V receiver, a printer, a speaker, and the like. Communication interface 305 may include any transceiver-like mechanism that enables computing device/server 300 to communicate with other devices and/or systems. For example, communication interface 305 may include mechanisms for communicating with another device or system via a network, such as a retail server or a server that wishes to use content server 115 to provide its services as discussed below. Further, communication interface 305 may include mechanisms for communicating with mobile device 125 via network 135.

As will be described in detail below, computing device 300 may perform operations based on software instructions that may be read into memory 310 from another computer-readable medium, such as data storage device 308, or from another device via communication interface 305. The software instructions contained in memory 310 cause processor 306 to perform various processes described herein. Alternatively, hardwired circuitry may be used in place of or in combination with software instructions to implement processes consistent with the present invention. Thus, various implementations are not limited to any specific combination of hardware circuitry and software.

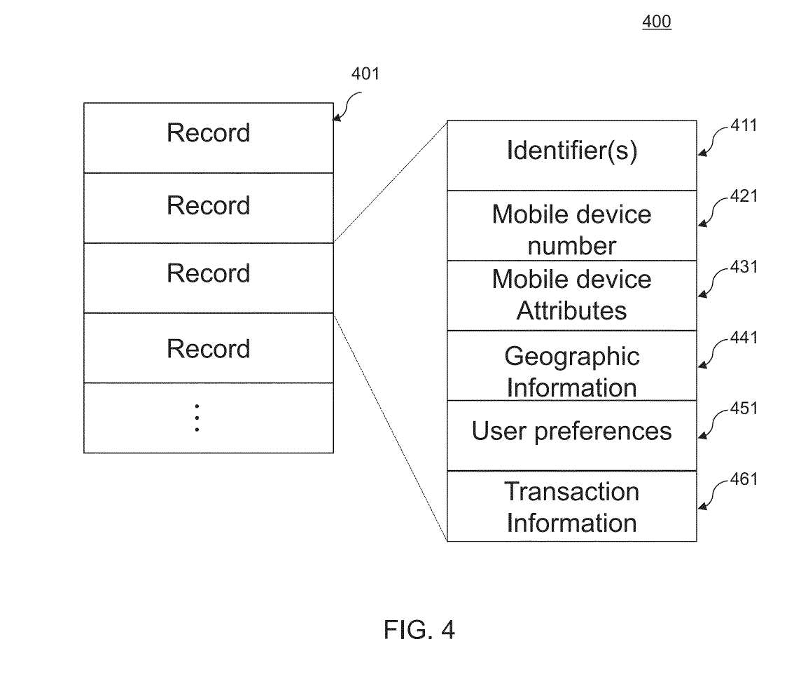

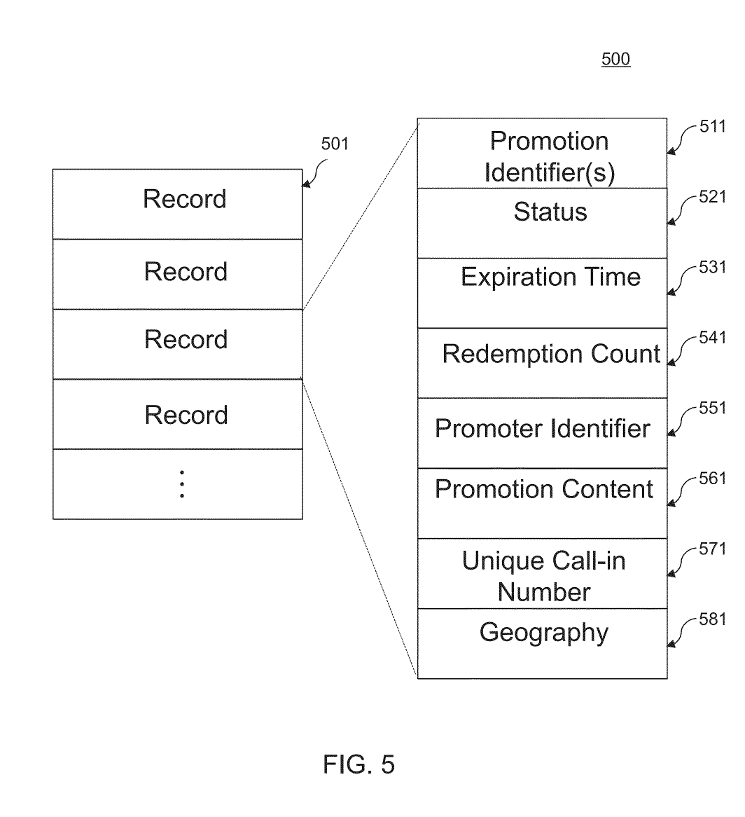

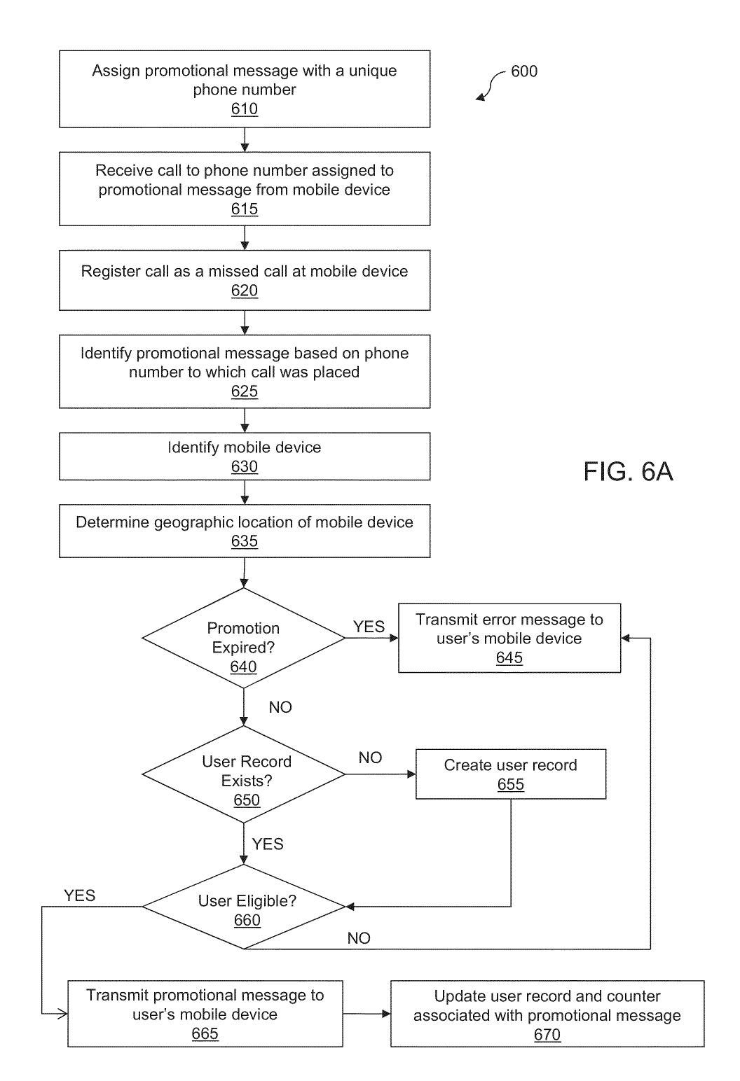

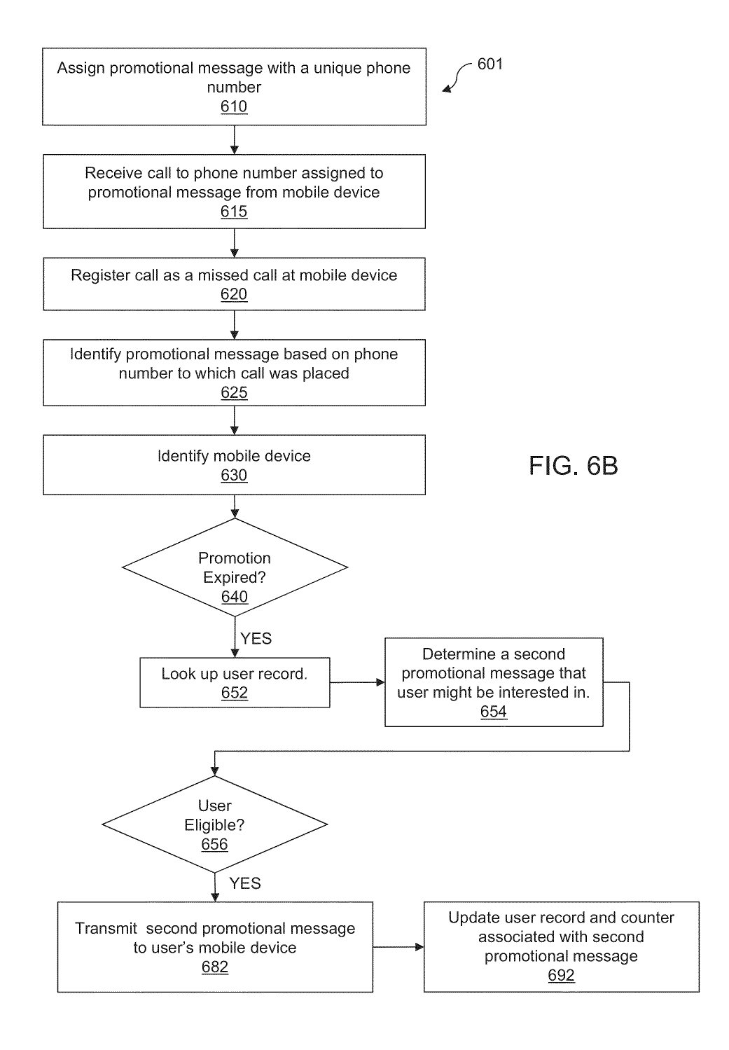

In some embodiments, memory 310 includes high-speed random access memory, such as DRAM, SRAM, DDR RAM, or other random access solid state memory devices; and may include non-volatile memory, such as one or more magnetic disk storage devices, optical disk storage devices, flash memory devices, or other non-volatile solid state storage devices. Memory 310 may optionally include one or more storage devices remotely located from the CPU(s) 306. Memory 310, or one or more of the storage devices (e.g., one or more non-volatile storage devices) in memory 310, includes a computer readable storage medium. In some embodiments, memory 310 or the computer readable storage medium of memory 310 stores the following programs, modules and data structures, or a subset thereof: an operating system 311 that includes procedures for handling various basic system services and for performing hardware dependent tasks; a network communication module 312 that is used for connecting computing device 300 to other computers via the one or more communication network interfaces 305 and one or more communication networks, such as the Internet, other wide area networks, local area networks, metropolitan area networks, and so on. Memory 310 may further store other applications, such as transaction module 313 for enabling transactions, as further described with reference to FIGS. 6A-9. Memory 310 and/or storage device 308 may further store a user database to store user records, as discussed further with reference to FIG. 4. Memory 310 and/or storage device 308 may further store a transaction database to store user records, as discussed further with reference to FIG. 5.

### Example Database Structures

FIG. 4 illustrates a block diagram of a database structure 400 for storing user account data, according to one embodiment. For example, the database structure 400 may be implemented in the user database 118 described with respect to FIG. 1. The database structure 400 contains a set of user account records. A respective user account record 401 may include such information as: (i) one or more user identifiers 411 associated with the user, if available, (e.g., user name, address, a unique identification number, user email address, a social networking identifier, etc.), and/or user account identifier (e.g., a user's account number associated with a retailer, user's loyalty program account information, etc.); (ii) a mobile phone number or other mobile phone identifier 421; (iii) attributes 431 for the user's mobile device, such as whether the mobile device renders GUIs; (iv) user's geographic location information 441; (v) user preference information 451 (e.g., user age); and (vi) transaction records 461 (such as unique serial numbers associated with promotional messages transmitted to user, merchandise credit for the user associated with the record 401, etc.).

FIG. 5 illustrates a block diagram of a database structure 500 for storing promotion data, according to one embodiment. For example, the database structure 500 may be implemented in the transaction database 119 described with respect to FIG. 1. The database structure 500 contains a set of promotion records. A respective promotion record 501 may include such information as: (i) one or more human-oriented identifiers 511 associated with the promotion (e.g., “BOGO promotion,” “5 off 15 promotion,” “Summer Sale”, “20% extra mileage bonus,” and/or a numerical identifier associated with the promotion etc.); (ii) a status 521 of the promotion, such as whether it is active or expired; (iii) an expiration date and time of the promotion 531; (iv) a redemption count of the promotion 541 (e.g., how many times a coupon has been transmitted, how many times a vote has been received, etc.); (v) an identifier for the promoter 551 (e.g., an identifier for the retailer issuing the coupon, an identifier for the TV show, etc.); (vi) promotional content 561 (such as graphics, logos, text, etc. to be used to create the promotion and/or terms and conditions associated with the promotion); (vii) the unique call-in number 571 assigned to the promotion (e.g., DID number); and (viii) the geography 581 in which the promotion is being run. In certain embodiments, a first unique call-in number can be associated for a first geography in which the promotion is run, a second unique call-in number for a second geography in which the promotion is run, and so forth. In certain embodiments, promotional content 561 may include a link to a second promotion, such that if the promotion 501 is expired or the user is otherwise ineligible for promotion 501, content server 115 may serve the second promotion.

### Example Processing Configuration

FIG. 6A illustrates a flowchart of a method 600 for transmitting a promotional message to a user's mobile device, according to one embodiment. In one embodiment, the steps of the method 600 are performed by the content server 115. In other embodiments, the method 600 may be performed by different entities, and may include additional, fewer, or different steps.

A promotional message (e.g., a promotion, a coupon, a rebate, a loyalty rewards program promotion, etc.) is assigned 610 with a phone number that is unique to the promotion. In some embodiments, the phone number is a direct inward dialing (DID) number. In one embodiment, the unique phone number assigned to the promotional message is a toll-free number. In one embodiment, an expiration date and/or time are also assigned to the promotional message, specifying a limit on the time the promotion is available to users.

The content server 115 receives 615 a call placed to the phone number assigned to the promotional message from the mobile device 125. For example, a user views or hears the promotional message via radio, television, in an email, in a printed publication, at a point of sale device, or the like. The promotional message includes the unique phone number assigned to the promotional message, which the user can call via the mobile device 125 to receive the promotional content associated with the message. The content server 115 may play a customized ring tone or message during the call. For example, the content server 115 may play a message including a brief summary or identification of the promotion, may thank the user for calling, provide instructions to the user, or the like. The content server 115 registers 620 the call at the mobile device 125 as a missed call so that the user does not incur an expense for the call.

The content server 115 identifies 625 the promotion the user is interested in based on the phone number to which the call was placed. In one embodiment, the content server 115 uses the phone number associated with the received call to perform a lookup of a record in the transaction database 119, such as the record 501 illustrated in FIG. 5.

The content server 115 identifies 630 the mobile device 125 based on the phone number of the mobile device 125. In one embodiment, the content server 115 identifies 630 the mobile device number using caller identification (caller ID). In cases where the phone number assigned to the promotion is a toll-free number, the caller ID of the mobile device is accessible to the content server 115 even if the user blocks caller ID on their mobile device 125.

The content server 115 determines 635 the geographical location of the mobile device 125. In one embodiment, the content server 115 determines 635 the geographical location based on geo-location information sent to the content server 115 by the mobile device 125 (e.g., as determined by a global positioning sensor of the mobile device 125). In another embodiment, the content server 115 determines 635 the geographical location of the mobile device 125 by looking up the record 401 associated with the phone number of the mobile device 125.

The content server 115 determines 640 whether the identified promotion is still active by, for example, performing a lookup of the record 501 in the transaction database 119. If the promotion is inactive, the content server 115 transmits 645 an error message to user's mobile device 125.

If the promotion has not expired, the content server 115 determines 650 if a record (such as the record 401) exists for the identified user in the user account database 118. If not, a user record 801 is created 655. If the record exists, the content server 115 determines 660 whether the user is eligible to receive the promotion. For example, the user may have already received the promotion a maximum number of times, the user may live in a geographical boundary in which the promotion is not valid, the user may be underage, etc. If the user is not eligible, content server 115 transmits 645 an error message to user's mobile device 125.

If the user is eligible for the promotion, the content server 115 transmits 665 the promotional message to the user's mobile device 125. To transmit the promotional message to the mobile device 125, the content server 115 may generate a unique serial number for the promotional message. In one embodiment, the unique serial number is generated by concatenating the (i) phone number associated with the promotion (which is unique to the promotion), (ii) the user's mobile device number (which is unique), and (iii) a unique token, for example having a specified length so that unique serial number can be processed by the promoter or retailer. For example, with a customer phone number of (415)333-4444, unique phone number assigned to the promotion of (456)777-1211, and a unique token of 1234, a unique serial number of 456777121141533344441234 is generated and associated with the promotional message transmitted to user's mobile device 125. The unique serial number can be used to recover a promotional message that is lost or deleted or otherwise inaccessible at mobile device 125. Further, since each serial number corresponding to a promotional message to the mobile device 125 is unique (due to the unique token), multiple transmissions of the same promotional message to the same mobile device 125 can be tracked.

The content server 115 updates 670 the user's record 401 and the promotion's record 501. For example, the content server 115 updates the user's record 401 to indicate that the user received the promotional content and updates the promotion's record 501 to increment the redemption count of the promotion.

FIG. 6B is a flowchart illustrating a method 601, which is an alternative embodiment of the method 600 illustrated in FIG. 6A. In one embodiment, method 601 includes steps similar to the steps of method 600. That is, the content server 115 may perform the steps 610-640 described with respect to FIG. 6A. However, responsive to determining 650 that a requested promotion has expired, the content server 115 performs 652 a lookup of the user record associated with the identified user. Based on the user information in the user record, such as the user's preferences, transaction information, and geographic information, the content server 115 determines 654 a second promotion in which the user may be interested. In some embodiments, the different promotion is selected based on a degree of similarity to the first promotion. For example, the second promotion is offered by the same retailer, or is the more current version of the first promotion. In some embodiments, the second promotion is specified by the promoter and is linked to the first promotion.

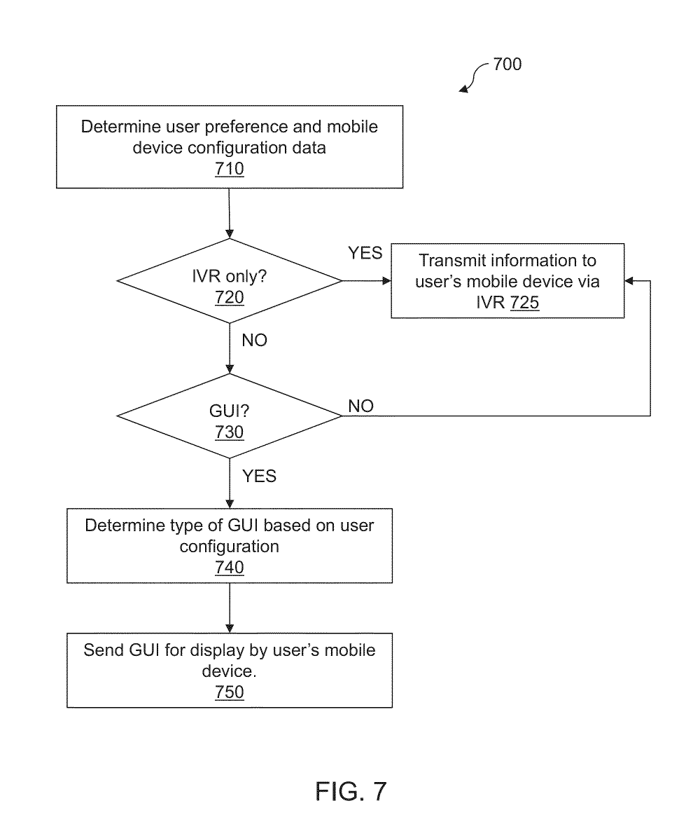

FIG. 7 illustrates a flowchart of a method 700 for transmitting a promotional message to a user's mobile device according to certain embodiments. As described with respect to FIG. 6A, the content server 115 receives a call from a mobile device 125 and identifies the mobile device 125 using caller ID. In some embodiments, as shown in FIG. 7, the content server 115 also determines 710 mobile device attributes, mobile device configuration data, and/or user preferences of the user associated with the mobile device 125. In one embodiment, the content server 115 determines 710 the device attributes by perform a lookup of the record 401 associated with mobile device number from which the call is received. Based on the mobile device attributes, mobile device configuration data, and/or user preferences, content server 115 determines the format in which content, including promotional content, is to be delivered to mobile device 125. If the content server determines 720 the mobile device 125 is configured for interactive voice response (IVR) but not configured to display a graphical user interface, the content server 115 transmits 725 information to the user's mobile device 125 via IVR. Otherwise, if the content server 115 determines 730 the mobile device 125 is capable of rendering a graphical user interface (GUI), the content server 115 determines 740 a type of GUI and sends 750 the GUI for display by the mobile device 125.

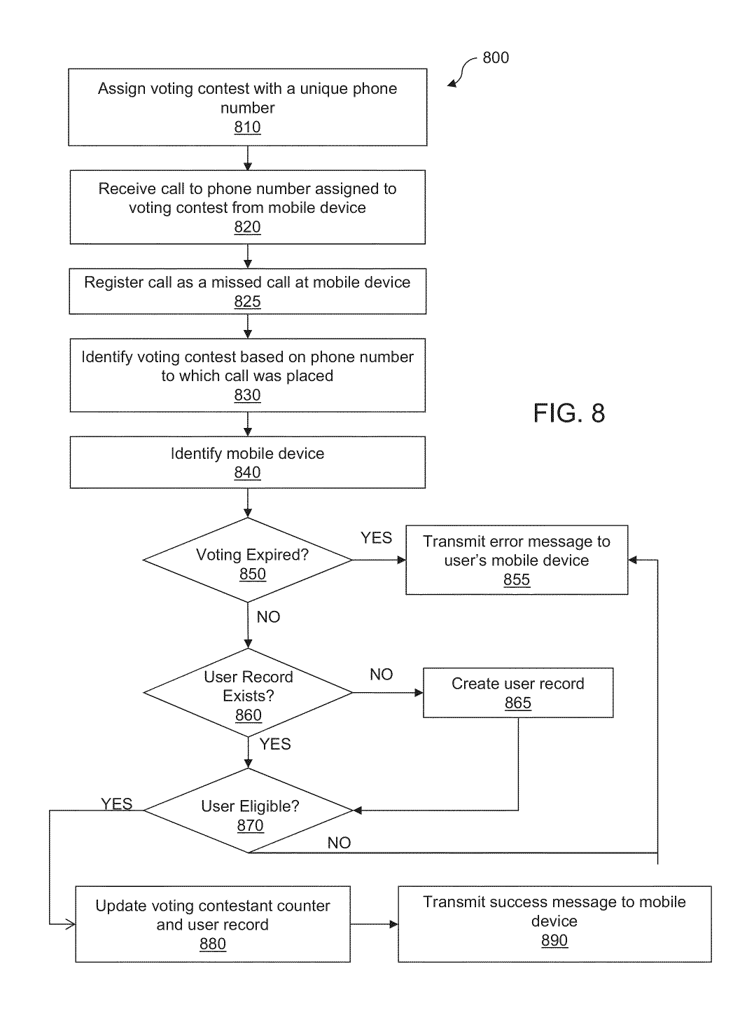

Although embodiments of the content server 115 have been described as providing promotional content, other embodiments of the content server 115 may perform alternative functions in response to receiving a call from a mobile device. For example, the content server 115 may use calls from mobile devices to count votes for contestants, such as contestants on a television show. FIG. 8 is a flowchart illustrating a method 800 for receiving a vote for a contestant from a user's mobile device, according to one embodiment. In one embodiment, the steps of the method 800 are performed by the content server 115. In other embodiments, the method 800 is performed by different entities, and may include different, additional, or fewer steps.

The content server 115 assigns 810 a unique phone number to the voting contest and/or contestant in the voting contest. For example, if the voting contest includes several contestants, the content server 115 may assign 810 a unique phone number to each contestant. In some embodiments, the phone number is a direct inward dialing (DID) number, and may be a toll-free number. The content server 115 may additionally assign an expiration date and/or time to the voting contest, specifying a period of time in which user votes will be counted for the contest.

The phone number assigned to the voting contest is presented to users via an audio and/or visual format. For example, if the voting contest is associated with a television show, the assigned phone number is displayed and/or a recording of the assigned phone number is played during the television show. Users desiring to place a vote during the contest use their mobile devices 125 to call the phone number assigned to the contest. The content server 115 receives 820 a call to the assigned phone number. The content server 115 may play a customized ring tone or message during the call. For example, the content server 115 may play a message including a brief summary or identification of the promotion, may thank the user for calling, provide instructions to the user, or the like. The content server 115 registers 825 the call at the mobile device 125 as a missed call so that the user does not incur an expense for the call.

The content server 115 identifies 830 the voting contest and the contestant for which the user is voting based on the phone number to which the call was placed. In one embodiment, the content server 115 uses the phone number to which the call was placed to perform a lookup of a record in a database of voting contests.

The content server 115 identifies 840 the mobile device 125 based on the phone number of the mobile device 125. For example, the content server 115 uses the device's phone number to perform a lookup of a record in the user accounts database 118.

The content server 115 determines 850 whether voting for the identified contest has expired by looking up an expiration time of the contest. If voting has expired, the content server 115 transmits 855 an error message to the user's mobile device 125.

If voting has not expired, the content server 115 determines 860 if a record exists for the mobile device 125 in the user account database 118. If not, a user record including the mobile device 125 is created 865. If the record exists, the content server 115 determines 870 whether the user is eligible to vote in the contest. For example, the user may be ineligible if the user has placed a maximum number of votes, is underage, or is located outside a geographical area associated with the contest. If the user is not eligible to vote in the contest, the content server 115 transmits 855 an error message to the user's mobile device 125.

If the user is eligible for voting in the contest, the content server 115 registers the user's vote based on the call and updates 880 the vote counter for the contest and/or contestant. The content server 115 may also update 880 the user record of the user, indicating that the user placed a vote in the contest. The content server 115 may transmit 890 a success or confirmation message to the mobile device 125, alerting the user to the successful vote.

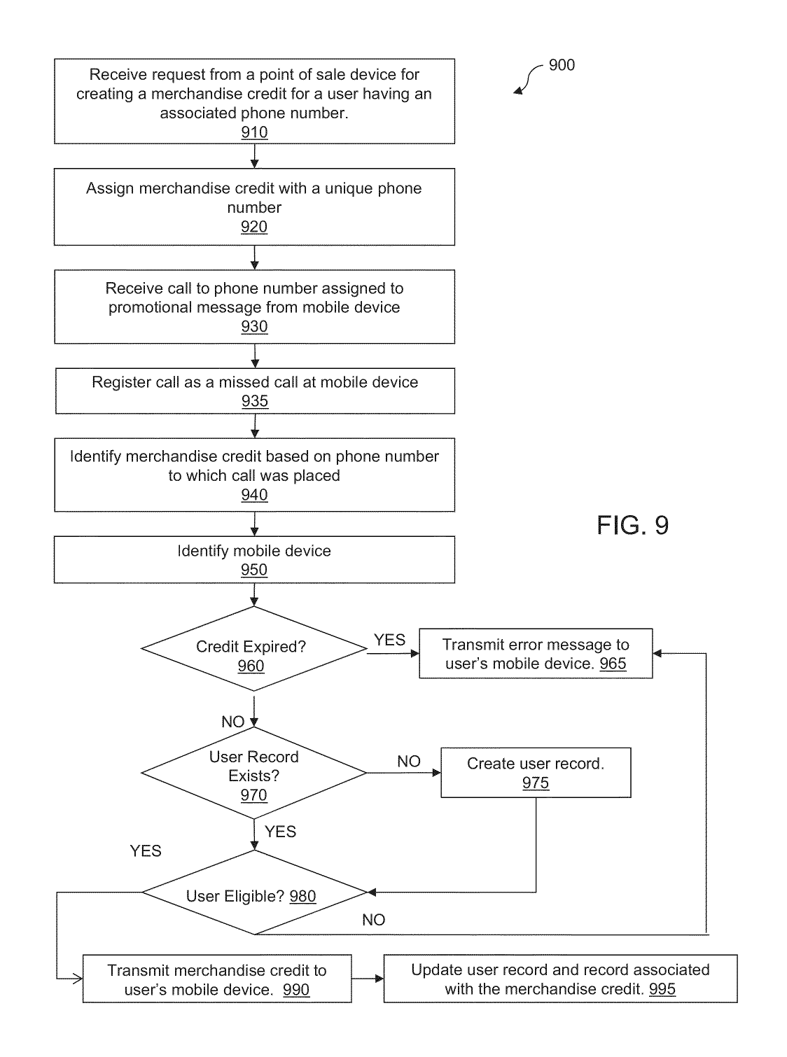

In another embodiment, the content server 115 serves requests for generating merchandise credit for a user that are initiated at a point of sale. FIG. 9 illustrates a flowchart of a method 900 for transmitting an electronic refund or merchandise credit to a user's mobile device according to certain embodiments. In one embodiment, the method 900 is performed by the content server 115 in communication with a point of sale device (e.g., a cash register) via one or more communication networks.

The content server 115 receives 910 a request from the point of sale device for creating a merchandise credit for a user. In response to receiving the request, the content server 115 assigns 920 a unique phone number to the merchandise credit and transmits the phone number to the user. For example, the content server 115 transmits the unique phone number to the point of sale device. In some cases, the content server assigns an expiration time to the merchandise credit and/or the phone number.

The user places a call to the assigned phone number using a mobile device 125. The content server 115 receives 930 the call, and in one embodiment plays a customized ringtone or message during the call. The content server 115 registers 935 the call as a missed call at the user's mobile device 125.

Based on the phone number to which the call was placed, the content server 115 identifies 940 the merchandise credit in which the user is interested. The content server 115 also identifies 950 the mobile device 125 used to place the call, for example based on caller ID.

The content server 115 determines 960 whether the merchandise credit has expired by looking up a record associated with the identified merchandise credit. If the credit has expired, the content server 115 transmits 965 an error message to the mobile device 125.

If the merchandise credit has not expired, the content server 115 determines 970 if a record exists for the mobile device 125 in the user account database 118. If not, a user record including the mobile device 125 is created 975. If the record exists, the content server 115 determines 980 whether the user is eligible to access and use the merchandise credit. For example, the user may be ineligible to user the merchandise credit if the user has already used the credit or if the point of sale device from which the user initiated the merchandise credit request is in a store that does not accept the credit. If the user is not eligible to access and use the merchandise credit, the content server 115 transmits 965 an error message to the user's mobile device 125.

If the user is eligible to use the merchandise credit, the content server 115 transmits 990 the merchandise credit to the user's mobile device 125 for use at the point of sale device. The content server 115 updates 895 the user's record 401 and a record of the merchandise credit. For example, the content server 115 updates the user's record 401 to indicate that the user used the merchandise credit and updates the merchandise credit's record to increment the redemption count of the credit.

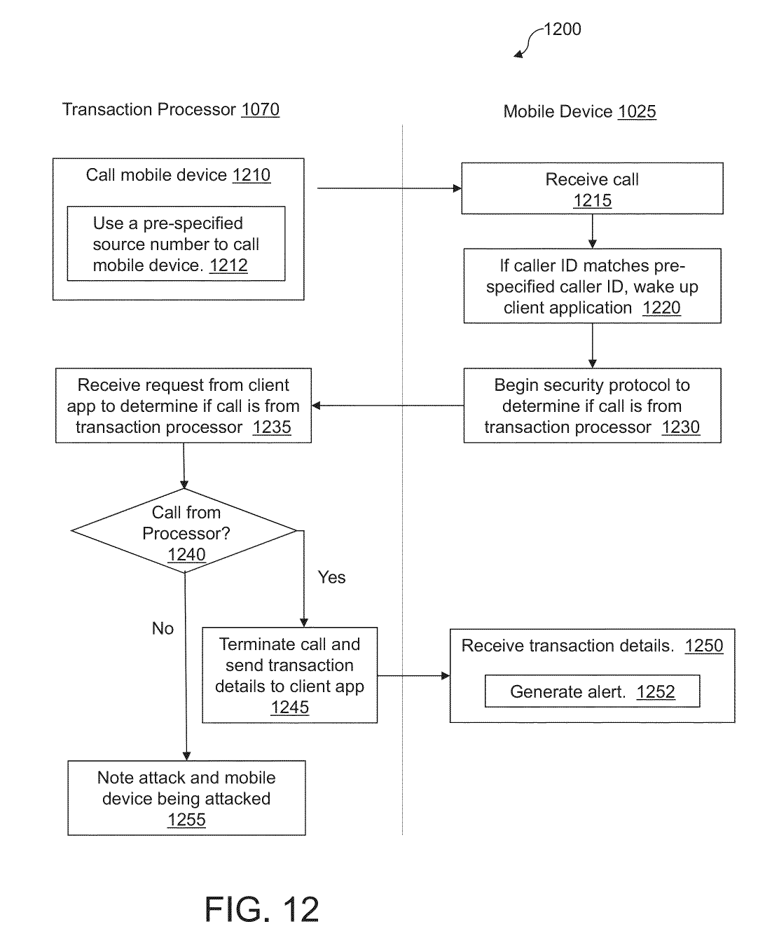

FIG. 10 depicts an exemplary networked environment 1005 in which systems and methods, consistent with exemplary embodiments, may be implemented. FIG. 10 is similar to FIG. 1, except that mobile device 1025 stores and executes a client application 1020, which, for example, may be a payment application. In one embodiment, client application 1020 may be provided (e.g., via download) to mobile device 1025 over network 1035 by transaction processor 1070 and may be used to provide client-side processing for performing desired tasks in response to operations selected by user of mobile device 1025. In one embodiment, client-side payment application 1020 may have a unique identifier and is uniquely tied to a mobile device identifier associated with user mobile device 1035. In one embodiment, client application 1020 may display a user interface in connection with a financial transaction initiated by user of mobile device 1025 using e.g., a browser application executing on mobile device 1025. As discussed further in FIGS. 11 and 12, transaction processor 1070 uses missed call notification to awaken client application 1020.

FIG. 11 illustrates a flowchart of a method 1100 for using a missed call to transmit information, such as details of a financial transaction, to a user's mobile device according to certain embodiments. In one embodiment, the method 1100 includes interactions between the transaction processor 1070 and the mobile device 1025.

Method 1100 begins with the transaction processor 1070 placing a call to the mobile device 1025 (1110). In some embodiments, transaction processor 1070 calls mobile device 1025 upon initiation of a transaction (e.g., a financial transaction), by a user associated with mobile device 1025. In some embodiments, transaction processor 1070 places a phone call to a mobile phone number or other mobile phone identifier associated with mobile device 1025. In some embodiments, the call is placed via a pre-specified caller number (1112). In some embodiments, the pre-specified caller number is one of a set (e.g. ten) caller numbers that can be used to place the call to mobile device 1025. In some embodiments, the set of caller numbers that can be used to place the call to mobile device 1025 is a subset of a larger number of caller numbers available to transaction processor 1070. In some embodiments, the set of caller numbers (which may in one embodiment, have a single member, and in another embodiment, multiple members) that can be used to place the call to mobile device 1025 is also provided in advance to client application 1020, for example when client application 1020 is installed upon mobile device 1025, or in later updates to client application 1020. In some embodiments, the set of caller numbers that can be used place the call to mobile device 1025 is periodically updated to improve security.

At 1115, mobile device 1025 receives the call placed by transaction processor 1070. In some embodiments, the operating system of mobile device 1025 provides a push notification to client application 1020 with the caller id of the received call causing client application 1020 to wake up (1120). For example, in the iOS environment, a VoIP flag can be used to alert the client application 1020 of the caller id. In order to save battery life, operating systems such as iOS may not allow client application 1020 to constantly run in the background. This method enables transaction processor 1070 to awaken and start running via a call to mobile device 1025. In some embodiments, client application 1020 only runs if the caller ID matches a pre-specified caller ID or is one of a set of pre-specified caller IDs stored as approved caller IDs. This step again ensures that the client application 1020 is less vulnerable to attack or hacking.

Transaction processor 1070 terminates call to mobile device 1025 and sends information, including transaction details, to client application 1020 (1130) over network 1035, which are received by client application 1020 (1135). The client application 1020 may optionally cause mobile device 1025 to generate an alert, such as a sound or vibratory alert, to alert the user of mobile device 1025 that transaction information has been received (1140).

Method 1100 may offer several advantages, such as low latency and reliability. Further, method 1100 provides certificate of delivery. Accordingly if transaction processor placed a call to a phone number, then it can be assumed with some reliability that the transaction information was delivered. Conversely, if the phone call was not received by mobile device 1025 (such as may be the case if the mobile device 1025 is out of service area or is powered off), then transaction information is not delivered. In some embodiments, if the transaction information is not delivered, then this information can be used to deny a transaction by transaction processor 1070. If however, the transaction information is successfully transmitted to client application 1020, then method 1100 has been able to do so without requiring any input from a user of mobile device 1025.

FIG. 12 illustrates a flowchart of a method 1200 for using a missed call to transmit information, such as details of a financial transaction, to a user's mobile device according to certain embodiments.

Method 1200 is similar to method 1100 except in some embodiments, for further security, client application 1020 initiates a security protocol to determine if call is indeed received from transaction processor 1070 (1230). In some embodiments, the security protocol includes an interrogation of transaction processor 1070. Transaction processor 1170 receives a request from client application 1020 to determine if transaction processor 1070 placed a call to mobile device (1235). If the call is indeed placed by transaction processor 1070 to mobile device 1025, then transaction processor 1070 terminates call to mobile device 1025 and sends transaction details to client application 1020 (1245). If the call has not been placed by transaction processor 1070, then transaction processor 1070 may take steps as necessary to prevent fraud and/or misuse or hacking For example, transaction processor 1070 may note the attack and notify the mobile device 1025 about the attack (1255).

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for transmitting promotional messages to mobile devices through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for providing a first promotional message associated with a first promotion to a mobile device, the method comprising:
assigning a phone number to the first promotion;
receiving a call to the phone number assigned to the first promotion from the mobile device;
registering the call as a missed call at the mobile device; and
responsive to receiving the missed call, transmitting the promotional message associated with the first promotion to the mobile device.

2. The method of claim 1, wherein transmitting the first promotional message to the mobile device comprises:
determining a phone number of the mobile device from the received call; and
transmitting the first promotional message to the mobile device using the determined phone number.

3. The method of claim 1, wherein transmitting the promotional message to the mobile device comprises:
generating a serial number for the first promotional message; and
storing an association between the serial number and an identifier of the mobile device.

4. The method of claim 1, wherein transmitting the first promotional message to the mobile device comprises:
generating a graphical user interface for display by the mobile device, the graphical user interface displaying the first promotional message.

5. The method of claim 1, further comprising:
determining whether the first promotional message has expired; and
responsive to determining the first promotional message has expired, transmitting an error message to the mobile device.

6. The method of claim 1, further comprising:
determining whether the first promotional message has expired; and
responsive to determining the first promotional message has expired, identifying a second promotional message; and
transmitting the second promotional message to the mobile device.

7. The method of claim 6, wherein identifying the second promotional message comprises:
determining a geographical location of the mobile device; and
identifying the second promotional message based on the geographical location of the mobile device.

8. The method of claim 6, wherein identifying the second promotional message comprises:
determining a second promotion similar to the first promotion, wherein the second promotional message is associated with the second promotion.

9. The method of claim 1, wherein the phone number assigned to the first promotion is a toll-free number.

10. The method of claim 1, wherein the first promotion is one selected from the group consisting of: an electronic refund, a rebate, a coupon, and an offer.

11. A system for providing a mobile device with promotional information, the server comprising:
a processor; and
a non-transitory computer readable storage medium storing computer program instructions for execution by the processor, the computer program instructions when executed by the processor causing the processor to perform steps comprising:
assigning a phone number to the first promotion;
receiving a call to the phone number assigned to the first promotion from the mobile device;
registering the call as a missed call at the mobile device; and
responsive to receiving the missed call, transmitting the promotional message associated with the first promotion to the mobile device.

12. The system of claim 11, wherein transmitting the first promotional message to the mobile device comprises:
determining a phone number of the mobile device from the received call; and
transmitting the first promotional message to the mobile device using the determined phone number.

13. The system of claim 11, wherein transmitting the promotional message to the mobile device comprises:
generating a serial number for the first promotional message; and
storing an association between the serial number and an identifier of the mobile device.

14. The system of claim 11, wherein transmitting the first promotional message to the mobile device comprises:
generating a graphical user interface for display by the mobile device, the graphical user interface displaying the first promotional message.

15. The system of claim 11, wherein the computer program instructions further comprise instructions that when executed by the processor cause the processor to perform steps comprising:
determining whether the first promotional message has expired; and
responsive to determining the first promotional message has expired, transmitting an error message to the mobile device.

16. The system of claim 11, wherein the computer program instructions further comprise instructions that when executed by the processor cause the processor to perform steps comprising:
determining whether the first promotional message has expired; and
responsive to determining the first promotional message has expired, identifying a second promotional message; and
transmitting the second promotional message to the mobile device.

17. The system of claim 16, wherein identifying the second promotional message comprises:
determining a geographical location of the mobile device; and
identifying the second promotional message based on the geographical location of the mobile device.

18. The system of claim 16, wherein identifying the second promotional message comprises:
determining a second promotion similar to the first promotion, wherein the second promotional message is associated with the second promotion.

19. The system of claim 11, wherein the phone number assigned to the first promotion is a toll-free number.

20. The system of claim 11, wherein the first promotion is one selected from the group consisting of: an electronic refund, a rebate, a coupon, and an offer.
